(19) United States
(12) Patent Application Publication
(10) Pub. No.: US 2022/0069697 A1
(43) Pub. Date: Mar. 3, 2022

(54) CONVERTER INCLUDING ACTIVE CLAMP SWITCH AND SECONDARY SIDE RECTIFIER AND CONTROLLING METHOD THEREOF

(71) Applicant: Sync Power Corp., Taipei City (TW)

(72) Inventors: Hsian-Pei YEE, Taipei City (TW); Chun-Jen HUANG, Taipei City (TW); Li-Min HUANG, Taipei City (TW)

(21) Appl. No.: 17/005,327

(22) Filed: Aug. 28, 2020

(51) Int. Cl. H02M 1/08; H02M 3/335; H02M 1/34

(52) U.S. Cl. CPC H02M 1/083; H02M 2001/346; H02M 1/34; H02M 3/33523

(57) ABSTRACT

A controlling method of a converter including an active clamp switch and a secondary side rectifier includes performing a state detecting step and a switch controlling step. The state detecting step is performed to detect an operation state of the secondary side rectifier. The switch controlling step is performed to control the active clamp switch according to the operation state of the secondary side rectifier.

### BACKGROUND

### Technical Field

The present disclosure relates to a converter and a controlling method thereof. More particularly, the present disclosure relates to a converter including an active clamp switch and a secondary side rectifier for energy recovery from active clamp and a controlling method thereof.

### Description of Related Art

A DC voltage is commonly required for operating an electric device. Therefore, an AC-DC power supply or a DC-DC power supply is needed for outputting a rectified DC voltage. A converter is commonly employed in such AC-DC (or DC-DC) power supply to convert a voltage. Many kinds of circuit topologies such as a forward topology, a flyback topology, a CUK topology, a full bridge topology, a half bridge topology and a push pull topology are used in the converter. Conventionally, a converter may include a primary side rectifier having a primary switch and a secondary side rectifier having a secondary side switch for modulating an outputted voltage.

In switch mode power supplies utilizing the aforementioned converters, a Zero Voltage Switching (ZVS) is desired for the primary switch; because of a relatively high voltage on the primary switch that induces a turn-on loss.

The conventional active clamp control has a key problem in a Discontinuous Current Mode (DCM), where the primary switch does not turn on after the transformer energy has been discharged to the output, thus the active clamp transistor is kept “ON” in the discontinued period (both the primary switch and the secondary side rectifier are “OFF”). With the active clamp transistor “ON”, the oscillation involves the snubber capacitor, which is many orders of magnitudes larger than the parasitic capacitance of the primary switch, thus the conduction loss of the active clamp switch makes the snubber once again loss process.

### SUMMARY

According to one aspect of the present disclosure, a controlling method of a converter including an active clamp switch and a secondary side rectifier is provided. The controlling method of the converter includes performing a state detecting step to detect an operation state of the secondary side rectifier and performing a switch controlling step to control the active clamp switch according to the operation state of the secondary side rectifier.

According to another aspect of the present disclosure, a controlling method of a converter including an active clamp switch and a secondary side rectifier is provided. The controlling method of the converter includes providing the active clamp switch in a primary side circuit; providing the secondary side rectifier in a secondary side circuit; performing a state detecting step to detect an operation state of the secondary side rectifier; and performing a switch controlling step to control the active clamp switch according to the operation state of the secondary side rectifier.

According to further another aspect of the present disclosure, a converter including an active clamp switch and a secondary side rectifier includes a primary side circuit and a secondary side circuit. The primary side circuit includes the active clamp switch. The secondary side circuit includes the secondary side rectifier having an operation state. The operation state of the secondary side rectifier of the secondary side circuit is detected to control the active clamp switch of the primary side circuit.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a controlling method of a converter according to a first embodiment of the present disclosure.

FIG. 2 shows a block diagram of a converter according to a second embodiment of the present disclosure.

FIG. 3 shows a flow chart of a controlling method of a converter according to a third embodiment of the present disclosure.

FIG. 4 shows a block diagram of a converter according to a fourth embodiment of the present disclosure.

FIG. 5 shows a first timing diagram associated with the converter of FIG. 4.

FIG. 6 shows a second timing diagram associated with the converter of FIG. 4.

FIG. 7 shows a third timing diagram associated with the converter of FIG. 4.

FIG. 8 shows a fourth timing diagram associated with the converter of FIG. 4.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “coupled to” another element, it can be directly coupled to the other element, or it can be indirectly coupled to the other element, that is, intervening elements may be present. In contrast, when an element is referred to as be “directly coupled to” another element, there are no intervening elements present. In addition, the terms first, second, third, etc. are used herein to describe various elements or components, these elements or components should not be limited by these terms. Consequently, a first element or component discussed below could be termed a second element or component.

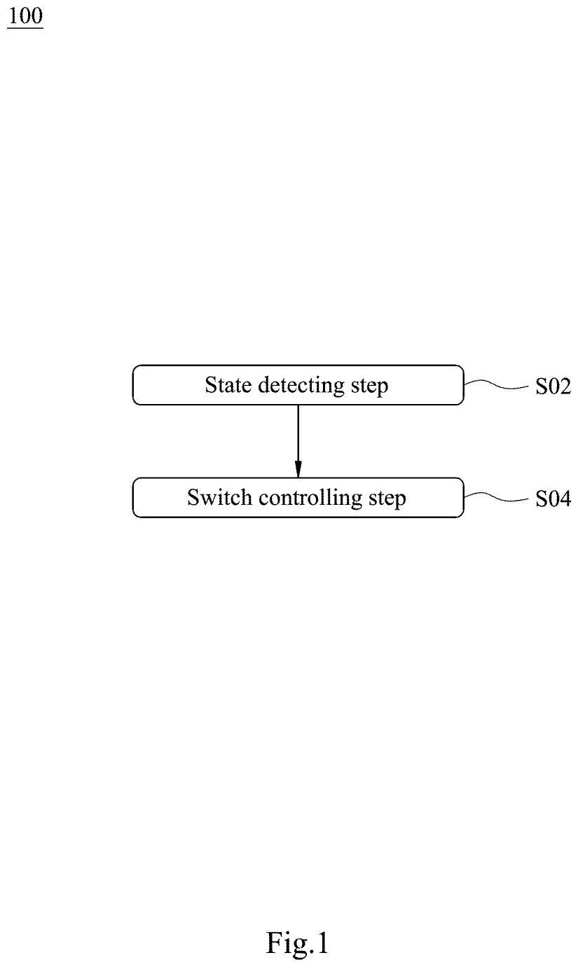

FIG. 1 shows a flow chart of a controlling method 100 of a converter according to a first embodiment of the present disclosure. In FIG. 1, the converter includes an active clamp switch and a secondary side rectifier. The controlling method 100 of the converter includes performing a state detecting step S02 to detect an operation state of the secondary side rectifier and performing a switch controlling step S04 to control the active clamp switch according to the operation state of the secondary side rectifier. Therefore, the controlling method 100 of the converter of the present disclosure utilizes the operation state of the secondary side rectifier to control the active clamp switch instead of shifting the turn-on time of the active clamp switch according to the timing of the primary switch, so that energy efficiency can be improved.

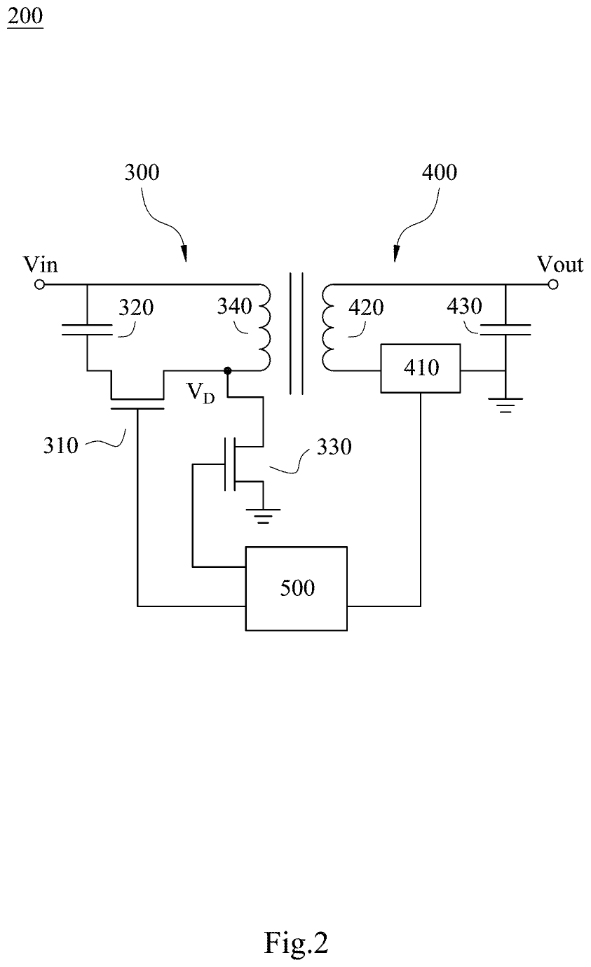

FIG. 2 shows a block diagram of a converter 200 according to a second embodiment of the present disclosure. In FIG. 2, the converter 200 includes a primary side circuit 300, a secondary side circuit 400 and a control unit 500.

The primary side circuit 300 includes an active clamp switch 310, a primary capacitor 320, a primary switch 330 and a primary winding 340. The active clamp switch 310 may be an NMOS transistor, but the present disclosure is not limited thereto. The primary capacitor 320 is coupled between an input power source and the active clamp switch 310. The input power source generates an input voltage Vin and may be a conventional AC source input including an AC power, a full bridge rectifier, etc. The primary switch 330 has a reflected voltage V_{D} thereon. The primary switch 330 is coupled to the active clamp switch 310, the primary winding 340, a ground and the control unit 500. The primary switch 330 may be an NMOS transistor, but the present disclosure is not limited thereto. The primary winding 340 has two winding ends. One of the two winding ends of the primary winding 340 is coupled to the input power source and the primary capacitor 320. Another of the two winding ends of the primary winding 340 is coupled to the active clamp switch 310 and the primary switch 330.

The secondary side circuit 400 includes a secondary side rectifier 410, a secondary winding 420 and a secondary capacitor 430. The secondary side rectifier 410 having an operation state. The operation state includes a conducting state, a blocking state and a transition state. The conducting state represents that the secondary side rectifier is turned on. The blocking state represents that the secondary side rectifier is turned off. The transition state represents that the secondary side rectifier transits from the conducting state to the blocking state. The secondary side rectifier 410 may be a diode or the NMOS transistor, but the present disclosure is not limited thereto. The secondary winding 420 is coupled to the secondary side rectifier 410. The secondary winding 420 and the primary winding 340 are configured to form an energy transformer to transfer energy from the primary side circuit 300 to the secondary side circuit 400. The secondary capacitor 430 is coupled to the secondary side rectifier 410 and the secondary winding 420. The secondary capacitor 430 generates an output voltage Vout.

The control unit 500 is coupled between the active clamp switch 310 and the secondary side rectifier 410. In other words, the control unit 500 is coupled between the primary side circuit 300 and the secondary side circuit 400. The control unit 500 is configured to implement the controlling method 100 of FIG. 1. The operation state of the secondary side rectifier 410 of the secondary side circuit 400 is detected to control the active clamp switch 310 of the primary side circuit 300. Therefore, the converter 200 utilizes the operation state of the secondary side rectifier 410 to control the active clamp switch 310 instead of shifting the turn-on time of the active clamp switch 310 according to the timing of the primary switch 330, so that energy efficiency can be improved.

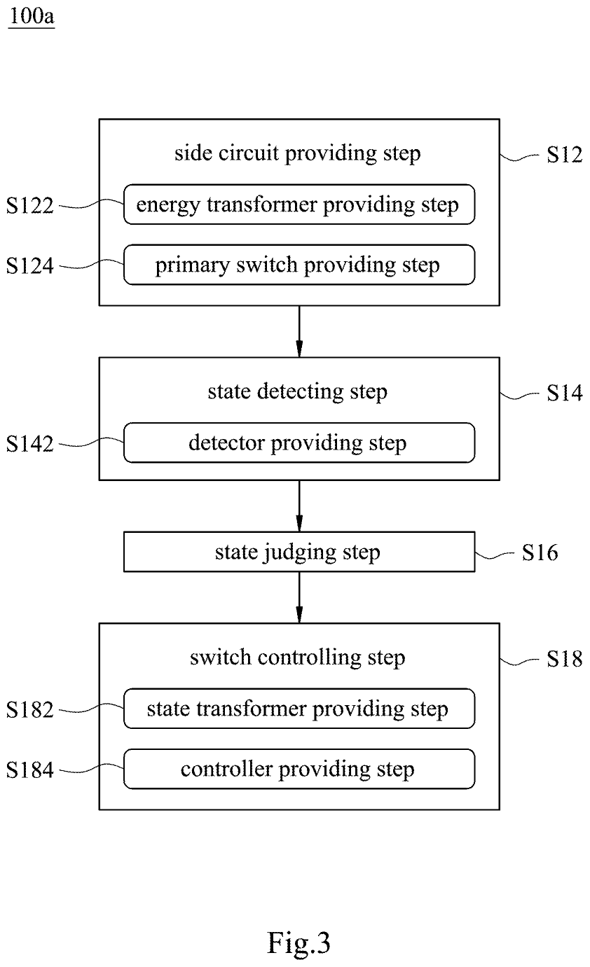

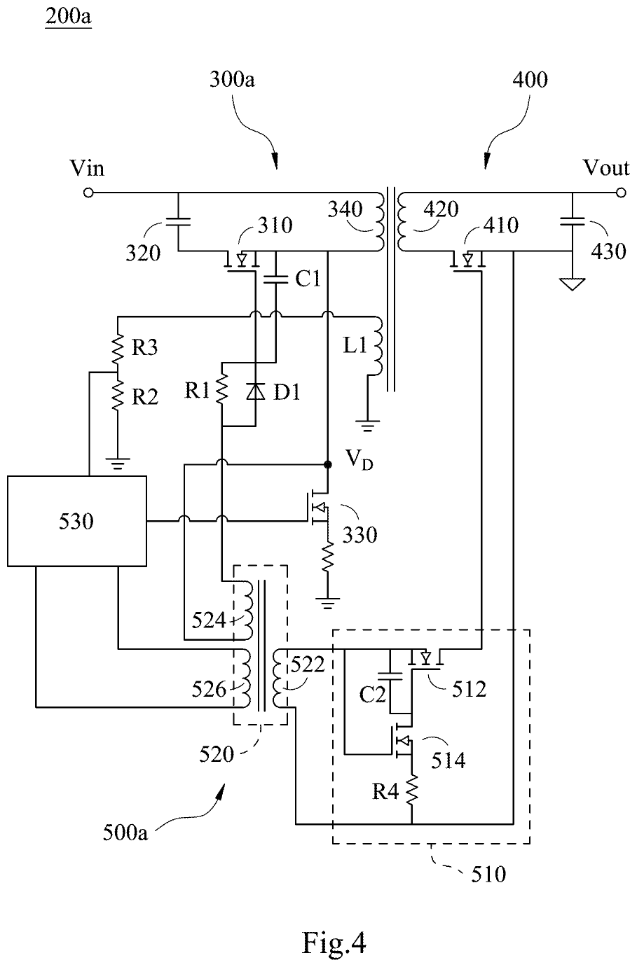

FIG. 3 shows a flow chart of a controlling method 100a of a converter 200a according to a third embodiment of the present disclosure. FIG. 4 shows a block diagram of the converter 200a according to a fourth embodiment of the present disclosure. In FIGS. 3 and 4, the converter 200a includes the active clamp switch 310 and the secondary side rectifier 410. The controlling method 100a of the converter 200a includes a side circuit providing step S12, a state detecting step S14, a state judging step S16 and a switch controlling step S18.

The side circuit providing step S12 is performed to provide the active clamp switch 310 and the secondary side rectifier 410 in the primary side circuit 300 and the secondary side circuit 400, respectively. In addition, the side circuit providing step S12 includes performing an energy transformer providing step S122 and a primary switch providing step S124. The energy transformer providing step S122 is performed to provide an energy transformer coupled between the active clamp switch 310 and the secondary side rectifier 410 to transfer energy. The primary switch providing step S124 is performed to provide a primary switch 330 coupled to the active clamp switch 310 and the energy transformer.

The state detecting step S14 is performed to detect an operation state of the secondary side rectifier 410. The state detecting step S14 includes performing a detector providing step S142 to provide a detector 510 coupled between the active clamp switch 310 and the secondary side rectifier 410 to detect the secondary side rectifier 410 so as to generate the operation state of the secondary side rectifier 410.

The state judging step S16 is performed to judge whether the operation state of the secondary side rectifier 410 is a conducting state, a blocking state or a transition state.

The switch controlling step S18 is performed to control the active clamp switch 310 according to the operation state of the secondary side rectifier 410. In response to determining that the operation state of the secondary side rectifier 410 is the conducting state in the state judging step S16, the active clamp switch 310 is turned on by the control unit 500 in the switch controlling step S18. In response to determining that the operation state of the secondary side rectifier 410 is the blocking state, the active clamp switch 310 is turned off by the control unit 500 in the switch controlling step S18. In response to determining that the operation state of the secondary side rectifier 410 is the transition state, the active clamp switch 310 is turned on and then turned off to excite a primary side oscillation for primary switch operation. In addition, the switch controlling step S18 includes performing a state transformer providing step S182 and a controller providing step S184. The state transformer providing step S182 is performed to provide a state transformer 520 coupled between the active clamp switch 310 and the detector 510 to control the active clamp switch 310 according to the operation state of the secondary side rectifier 410. The controller providing step S184 is performed to provide a controller 530 coupled between the state transformer 520 and the primary switch 330 to control the primary switch 330 according to the operation state of the secondary side rectifier 410.

Therefore, the controlling method 100a of the converter 200a utilizes the operation state of the secondary side rectifier 410 to control the active clamp switch 310 instead of shifting the turn-on time of the active clamp switch 310 according to the timing of the primary switch 330, so that energy efficiency can be improved.

In FIG. 4, the converter 200a includes a primary side circuit 300a, a secondary side circuit 400 and a control unit 500a. The detail of the secondary side circuit 400 is the same as the secondary side circuit 400 of FIG. 2, and will not be described again herein. In FIG. 4, the primary side circuit 300a includes an active clamp switch 310, a primary capacitor 320, a primary switch 330, a primary winding 340 and a resistor RP. The detail of the active clamp switch 310, the primary capacitor 320, the primary switch 330 and the primary winding 340 is the same as the active clamp switch 310, the primary capacitor 320, the primary switch 330 and the primary winding 340 of FIG. 2. The resistor RP is coupled between the primary switch 330 and the ground.

The control unit 500a includes a detector 510, a state transformer 520, a controller 530, a first resistor R1, a second resistor R2, a third resistor R3, a diode D1, a first capacitor C1 and a control winding L1. The detector 510 is coupled between the active clamp switch 310 and the secondary side rectifier 410 to detect the secondary side rectifier 410 so as to generate the operation state of the secondary side rectifier 410. In detail, the detector 510 includes a first detecting switch 512, a second detecting switch 514, a second capacitor C2 and a fourth resistor R4. The first detecting switch 512 is coupled to the secondary side rectifier 410, the second detecting switch 514, the second capacitor C2 and the state transformer 520. The second detecting switch 514 is coupled to the first detecting switch 512, the second capacitor C2, the state transformer 520 and the fourth resistor R4. The second capacitor C2 is coupled to the first detecting switch 512, the second detecting switch 514 and the state transformer 520. The fourth resistor R4 is coupled to the second detecting switch 514, the state transformer 520 and the secondary side rectifier 410. Moreover, the state transformer 520 is coupled between the active clamp switch 310 and the detector 510 to control the active clamp switch 310 according to the operation state of the secondary side rectifier 410. In detail, the state transformer 520 includes a first winding 522, a second winding 524 and a third winding 526. The first winding 522 is coupled to the detector 510. The second winding 524 is coupled to the primary switch 330, the first resistor R1 and the diode D1. The third winding 526 is coupled to the controller 530. In addition, the controller 530 is coupled between the state transformer 520 and the primary switch 330 to control the primary switch 330 according to the operation state of the secondary side rectifier 410. The controller 530 is coupled to the third winding 526, the primary switch 330, the second resistor R2 and the third resistor R3. The first resistor R1 and the diode D1 are coupled between the active clamp switch 310 and the second winding 524. The first capacitor C1 is coupled to the first resistor R1, the diode D1 and the active clamp switch 310. The third resistor R3 is coupled between the second resistor R2 and the control winding L1. The control winding L1 is coupled to the energy transformer, i.e., the control winding L1 is coupled to the secondary winding 420.

Therefore, the converter 200a utilizes the operation state of the secondary side rectifier 410 of the secondary side circuit 400 to control the active clamp switch 310 of the primary side circuit 300a instead of shifting the turn-on time of the active clamp switch 310 according to the timing of the primary switch 330, so that energy efficiency can be improved.

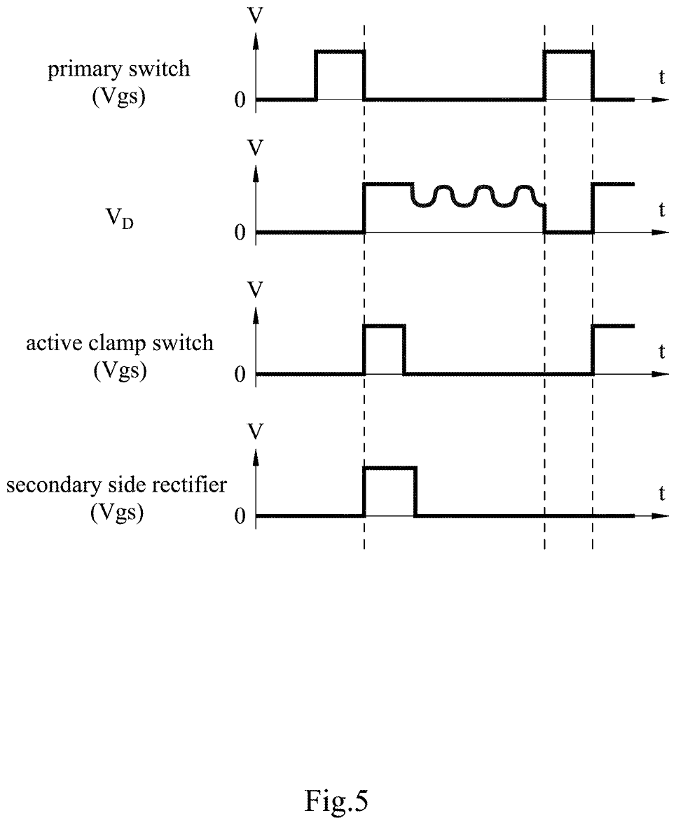

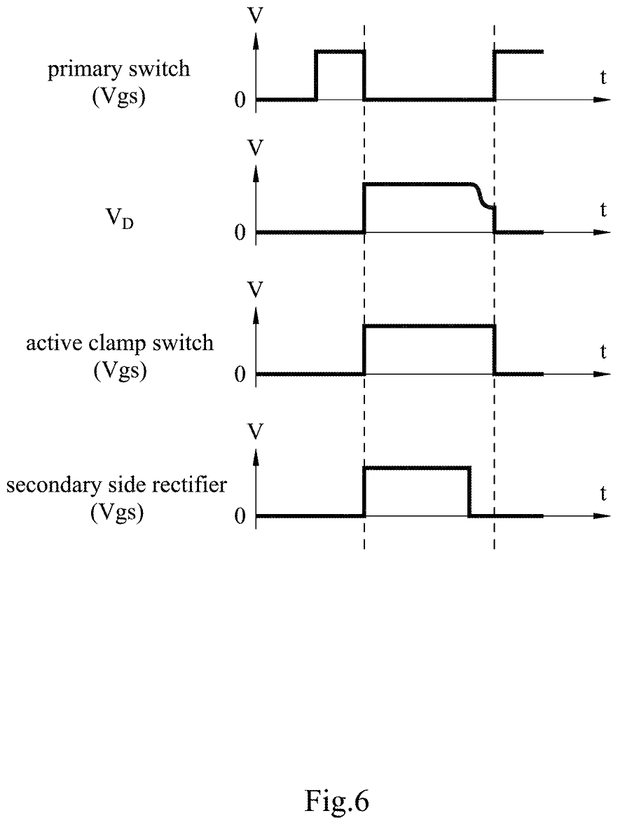

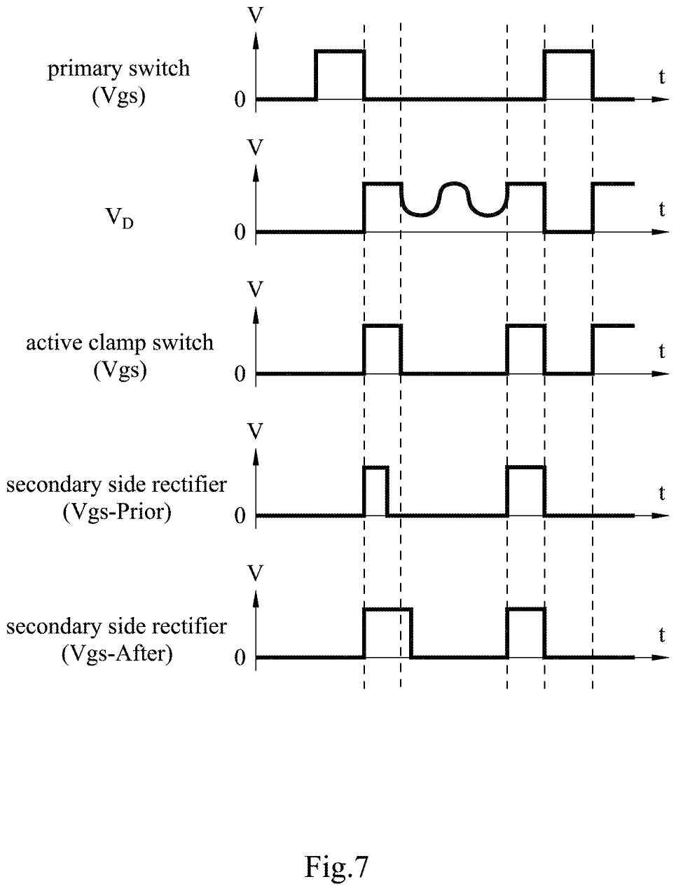

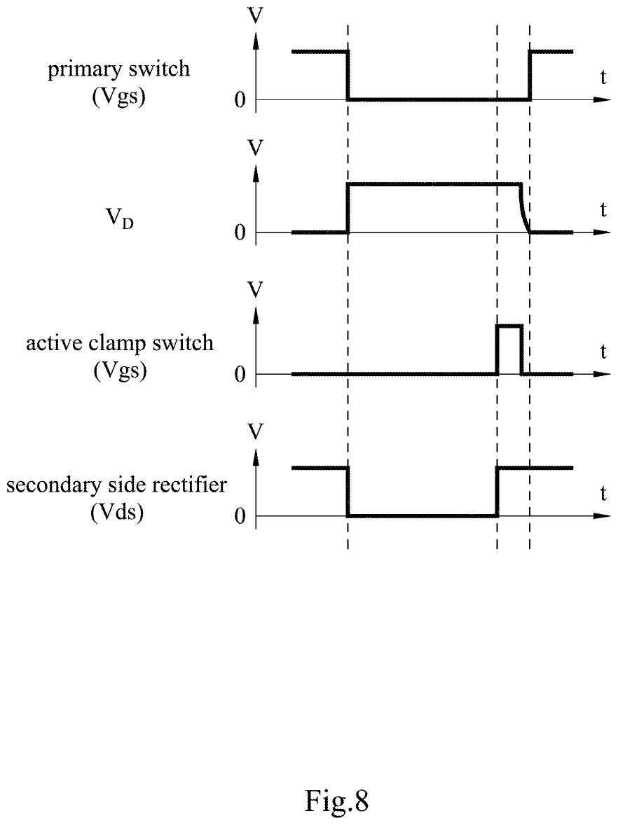

FIG. 5 shows a first timing diagram associated with the converter 200a of FIG. 4. FIG. 6 shows a second timing diagram associated with the converter 200a of FIG. 4. FIG. 7 shows a third timing diagram associated with the converter 200a of FIG. 4. FIG. 8 shows a fourth timing diagram associated with the converter 200a of FIG. 4. In FIGS. 4-8, the operation state of the secondary side rectifier 410 is utilized to control the active clamp switch 310 instead of shifting the turn-on time of the active clamp switch 310 according to the timing of the primary switch 330. The operation state of the secondary side rectifier 410 is reflected at a primary switch node. The primary switch node is located between the active clamp switch 310 and the primary switch 330, and has a reflected voltage V_{D}. When the operation state of the secondary side rectifier 410 is the conducting state (i.e., the secondary side rectifier 410 is turned on), the reflected voltage V_{D} of the primary switch node is equal to Vin plus nVout (i.e., V_{D}=Vin+nVout), where Vin is an input voltage of the converter 200a, n is a transformer winding ratio between the primary winding 340 and the secondary winding 420, and Vout is an output voltage of the converter 200a. The reflected voltage V_{D} of the primary switch node may be utilized to control the active clamp switch 310, specially the turn-off of the active clamp switch 310. The active clamp switch 310 can be turned off prior to, along with or after the drop of the reflected voltage V_{D} (i.e., the reflected voltage V_{D} of the primary switch node is unequal to Vin plus nVout).

In FIG. 5, the first timing diagram represents “Prior”, i.e., the active clamp switch 310 is turned off prior to the drop of the reflected voltage V_{D}. Vgs represents a gate-source voltage of the transistor. The primary capacitor 320 (i.e., a snubber capacitor) does not become a part of a Discontinuous Current Mode (DCM) parasitic oscillation. Thus, no loss will be incurred from the oscillation with the primary capacitor 320, and loss will be only incurred from the oscillation with parasitic capacitance. The timing diagram of “Along” (i.e., the active clamp switch 310 is turned off along with the drop of the reflected voltage V_{D}) is same as the timing diagram of “Prior” in FIG. 5.

In FIG. 6, the second timing diagram represents “After”, i.e., the active clamp switch 310 is turned off after the drop of the reflected voltage V_{D}. When the secondary side rectifier 410 is turned off, the reflected voltage V_{D} is not locked to Vin+nVout, and the active clamp switch 310 is still turned on. The primary capacitor 320 is a part of the oscillation by pushing current back through the energy transformer. When the active clamp switch 310 is turned off, the transformer/leakage inductance demands the same current from the parasitic capacitance so as to cause the reflected voltage V_{D} to be sharply moved lower towards zero and give the primary switch 330 the opportunity to turn on at a Zero Voltage Switching (ZVS) condition.

In FIG. 7, the same ZVS condition can be achieved at a very light load. The active clamp switch 310 may be turned off with “Prior” or “Along”. Loss will be only incurred from the oscillation with parasitic capacitance. Before the primary switch 330 is turned on, the active clamp switch 310 is turned on (i.e., second turn on) to participate in the oscillation, and then quickly turned off to ZVS in the same fashion of FIG. 6.

In FIG. 8, the transition state of the secondary side rectifier 410 is used to control the active clamp switch 310 for ZVS. In response to determining that the operation state of the secondary side rectifier 410 is the transition state (e.g., from the conducting state to the blocking state), the active clamp switch 310 is turned on and then turned off to excite the primary side oscillation for primary switch operation.

According to the aforementioned embodiments and examples, the advantages of the present disclosure are described as follows.

1. The controlling method of the present disclosure utilizes the operation state of the secondary side rectifier to control the active clamp switch instead of shifting the turn-on time of the active clamp switch according to the timing of the primary switch, so that energy efficiency can be effectively improved.

2. The converter of the present disclosure utilizes the operation state of the secondary side rectifier to control the active clamp switch instead of shifting the turn-on time of the active clamp switch according to the timing of the primary switch, thereby effectively improving energy efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A controlling method of a converter including an active clamp switch and a secondary side rectifier, comprising:
performing a state detecting step to detect an operation state of the secondary side rectifier; and
performing a switch controlling step to control the active clamp switch according to the operation state of the secondary side rectifier.

2. The controlling method of the converter including the active clamp switch and the secondary side rectifier of claim 1, further comprising:
performing a state judging step to judge whether the operation state of the secondary side rectifier is a conducting state, wherein the conducting state represents that the secondary side rectifier is turned on.

3. The controlling method of the converter including the active clamp switch and the secondary side rectifier of claim 2, wherein,
in response to determining that the operation state of the secondary side rectifier is the conducting state, the active clamp switch is turned on; and
in response to determining that the operation state of the secondary side rectifier is a blocking state, the active clamp switch is turned off.

4. The controlling method of the converter including the active clamp switch and the secondary side rectifier of claim 1, further comprising:
performing a state judging step to judge whether the operation state of the secondary side rectifier is a transition state, wherein the transition state represents that the secondary side rectifier transits from a conducting state to a blocking state.

5. The controlling method of the converter including the active clamp switch and the secondary side rectifier of claim 1, wherein,
in response to determining that the operation state of the secondary side rectifier is a transition state, the active clamp switch is turned on and then turned off to excite a primary side oscillation for primary switch operation.

6. The controlling method of the converter including the active clamp switch and the secondary side rectifier of claim 1, further comprising:
a side circuit providing step, comprising:
performing an energy transformer providing step to provide an energy transformer coupled between the active clamp switch and the secondary side rectifier to transfer energy; and
performing a primary switch providing step to provide a primary switch coupled to the active clamp switch and the energy transformer.

7. The controlling method of the converter including the active clamp switch and the secondary side rectifier of claim 1, wherein the active clamp switch is a first transistor, and the secondary side rectifier is a diode or a second transistor.

8. The controlling method of the converter including the active clamp switch and the secondary side rectifier of claim 1, wherein the state detecting step comprises:
performing a detector providing step to provide a detector coupled between the active clamp switch and the secondary side rectifier to detect the secondary side rectifier so as to generate the operation state of the secondary side rectifier;
wherein the operation state is one of a conducting state, a blocking state and a transition state.

9. The controlling method of the converter including the active clamp switch and the secondary side rectifier of claim 8, wherein the switch controlling step comprises:
performing a state transformer providing step to provide a state transformer coupled between the active clamp switch and the detector to control the active clamp switch according to the operation state of the secondary side rectifier.

10. The controlling method of the converter including the active clamp switch and the secondary side rectifier of claim 9, wherein the switch controlling step further comprises:
performing a controller providing step to provide a controller coupled between the state transformer and a primary switch to control the primary switch according to the operation state of the secondary side rectifier.

11. A controlling method of a converter including an active clamp switch and a secondary side rectifier, comprising:
performing a side circuit providing step to provide the active clamp switch and the secondary side rectifier in a primary side circuit and a secondary side circuit, respectively;
performing a state detecting step to detect an operation state of the secondary side rectifier; and
performing a switch controlling step to control the active clamp switch according to the operation state of the secondary side rectifier.

12. The controlling method of the converter including the active clamp switch and the secondary side rectifier of claim 11, further comprising:
performing a state judging step to judge whether the operation state of the secondary side rectifier is a conducting state, wherein the conducting state represents that the secondary side rectifier is turned on.

13. The controlling method of the converter including the active clamp switch and the secondary side rectifier of claim 12, wherein,
in response to determining that the operation state of the secondary side rectifier is the conducting state, the active clamp switch is turned on; and
in response to determining that the operation state of the secondary side rectifier is a blocking state, the active clamp switch is turned off.

14. The controlling method of the converter including the active clamp switch and the secondary side rectifier of claim 11, further comprising:
performing a state judging step to judge whether the operation state of the secondary side rectifier is a transition state, wherein the transition state represents that the secondary side rectifier transits from a conducting state to a blocking state.

15. The controlling method of the converter including the active clamp switch and the secondary side rectifier of claim 14, wherein,
in response to determining that the operation state of the secondary side rectifier is the transition state, the active clamp switch is turned on and then turned off to excite a primary side oscillation for primary switch operation.

16. The controlling method of the converter including the active clamp switch and the secondary side rectifier of claim 11, wherein the side circuit providing step comprises:
performing an energy transformer providing step to provide an energy transformer coupled between the active clamp switch and the secondary side rectifier to transfer energy; and
performing a primary switch providing step to provide a primary switch coupled to the active clamp switch and the energy transformer in the primary side circuit.

17. The controlling method of the converter including the active clamp switch and the secondary side rectifier of claim 11, wherein the active clamp switch is a first transistor, and the secondary side rectifier is a diode or a second transistor.

18. The controlling method of the converter including the active clamp switch and the secondary side rectifier of claim 11, wherein the state detecting step comprises:
performing a detector providing step to provide a detector coupled between the active clamp switch and the secondary side rectifier to detect the secondary side rectifier so as to generate the operation state of the secondary side rectifier;
wherein the operation state is one of a conducting state, a blocking state and a transition state.

19. The controlling method of the converter including the active clamp switch and the secondary side rectifier of claim 18, wherein the switch controlling step comprises:
performing a state transformer providing step to provide a state transformer coupled between the active clamp switch and the detector to control the active clamp switch according to the operation state of the secondary side rectifier.

20. The controlling method of the converter including the active clamp switch and the secondary side rectifier of claim 19, wherein the switch controlling step further comprises:
performing a controller providing step to provide a controller coupled between the state transformer and a primary switch to control the primary switch according to the operation state of the secondary side rectifier.

21. A converter including an active clamp switch and a secondary side rectifier, comprising:
a primary side circuit, wherein the primary side circuit comprises the active clamp switch; and
a secondary side circuit, wherein the secondary side circuit comprises the secondary side rectifier having an operation state;
wherein the operation state of the secondary side rectifier of the secondary side circuit is detected to control the active clamp switch of the primary side circuit.

22. The converter including the active clamp switch and the secondary side rectifier of claim 21, wherein,
the primary side circuit further comprises a primary winding coupled to the active clamp switch; and
the secondary side circuit further comprises a secondary winding coupled to the secondary side rectifier;
wherein the primary winding and the secondary winding are configured to form an energy transformer to transfer energy from the primary side circuit to the secondary side circuit;
wherein the primary side circuit further comprises a primary switch coupled to the active clamp switch and the primary winding.

23. The converter including the active clamp switch and the secondary side rectifier of claim 21, further comprising:
a control unit coupled between the active clamp switch and the secondary side rectifier, wherein the control unit is configured to implement a controlling method of the converter comprising:
performing a state detecting step to detect the operation state of the secondary side rectifier; and
performing a switch controlling step to control the active clamp switch according to the operation state of the secondary side rectifier, wherein the operation state is one of a conducting state, a blocking state and a transition state.

24. The converter including the active clamp switch and the secondary side rectifier of claim 23, wherein the control unit comprises:
a detector coupled between the active clamp switch and the secondary side rectifier to detect the secondary side rectifier so as to generate the operation state of the secondary side rectifier;
a state transformer coupled between the active clamp switch and the detector to control the active clamp switch according to the operation state of the secondary side rectifier; and
a controller coupled between the state transformer and a primary switch to control the primary switch according to the operation state of the secondary side rectifier.
